(19) United States
(12) Patent Application Publication
(10) Pub. No.: US 2015/0363486 A1
(43) Pub. Date: Dec. 17, 2015

(54) Device for Generating Attribute Data for Facility and Tangible Non-Transitory Computer-Readable Storage Medium Storing Computer Program for Generating Attribute Data for Facility

(71) Applicant: TOYOTA MAPMASTER INCORPORATED, Nagoya-shi, Aichi (JP)

(72) Inventors: Masaya Shimizu, Nagoya-shi, Aichi-ken (JP); Kazuhito Baba, Nagoya-shi, Aichi-ken (JP); Kazumi Murai, Toyota-shi, Aichi-ken (JP)

(73) Assignee: TOYOTA MAPMASTER INCORPORATED, Nagoya-shi, Aichi-ken (JP)

(21) Appl. No.: 14/761,570

(22) PCT Filed: Jan. 18, 2013
(86) PCT No.: PCT/JP2013/050976

§ 371 Date: Jul. 16, 2015

(51) Int. Cl. G06F 17/30; A63F 13/30

(52) U.S. Cl. CPC G06F 17/30654; G06F 17/30864; A63F 13/30

(57) ABSTRACT

The present invention pertains to a device for generating attribute data for a facility from log data of a game in which a facility assumed by a user is guessed by an interactive question form. Provided is a game in which a facility assumed by a user is guessed by an interactive question form, wherein log data of questions and answers obtained from the game is associated with the facility and stored in a log database, a facility serving as a subject for generating attribute data pertaining to the facility is specified as a subject facility, log data pertaining to the specified subject facility is extracted from the log database, and attribute data pertaining to the subject facility is generated on the basis of the extracted log data.

### FIELD OF INVENTION

The present invention relates to a method and a device for generating attribute data for a facility based on log data items obtained in a game for guessing a facility assumed by a user through an interactive question-answering process.

### BACKGROUND ART

With the widespread use of navigation devices in recent years, facility databases used for searching for certain facilities in navigation devices have been improved greatly. Such facility databases store facility names in association with their static attributes, such as addresses, phone numbers, business hours, and fees.

Also, there is a known system configured to identify, through an interactive question-answering process, a person or a character that a user is thinking of based on the user's answers to questions asked (non-patent document 1).

The patent document 1 describing a conventional art relating to the present invention should also be referred to.

### PRIOR ART DOCUMENT

### Patent Document

Patent Document 1: JP 2007-322836 A

### Non-Patent Document

Non-Patent Document 1: [Online search on Dec. 24, 2012] Internet <URL: http://ja.wikipedia.org/wiki/Akinator>

### SUMMARY OF THE INVENTION

### Problems to be Solved by the Invention

In performing the facility search, when a user has already narrowed down the facility or the search target the user wants to visit, the user can readily start the search by accessing the facility databases.

Even when the user hasn't narrowed down the search target in another case, the user may have some sensory images relating to a facility that the user wants to search for. Examples of the sensory images include “family-oriented fun facility” and “stress-free healing place”. Yet, such an image-based facility search may not be possible with some of the existing facility databases. Therefore, the inventors of the present invention earnestly studied approaches for generating attribute data items for facilities useful in a user's facility search incorporating the user's sensory images, and then finally arrived at the idea of generating attribute data items based on users' sensory images by using log data items having questions and answers obtained in a game for guessing predetermined facilities assumed by a user through an interactive question-answering process.

### Solutions to the Problems

The invention was accomplished to solve the problem described earlier. A first aspect of the invention provides a device for generating attribute data for a facility defined as below and includes:

a log database that stores log data items including questions and answers obtained in a game for guessing a facility assumed by a user through an interactive question-answering process, the log data items being stored in the log database in association with the facility;

a target facility identifying unit that identifies a facility as a target facility, for which attribute data relating to the facility is to be generated;

a log data extracting unit for extracting one or more of the log data items relating to the identified target facility from the log database; and

an attribute data generating unit that generates the attribute data relating to the target facility based on the extracted log data items.

The attribute data generating device according to the first aspect defined as above extracts one or more of the log data items relating to the target facility for which attribute data is to be generated from the log data items of questions and answers obtained from the game for guessing a facility assumed by a user through an interactive question-answering process, and generates the attribute data for the target facility based on the extracted log data items. Because the log data items of the questions and the answers obtained from the game are used, it is possible to derive the user's sensory image relating to the target facility from the user's answers to the questions asked to generate attribute data incorporating the image.

Examples of the game for guessing the predetermined facilities through the interactive question-answering process include a game, in which questions associated with the facilities and answers to the questions are prepared in advance. Then, the prepared answers are compared with a user's answer to the question based on the user's sensory image relating to the facility in order to determine the name of the facility assumed by the user.

The attribute data refers to information containing attributes incorporating a user's sensation about the target facility, for example, a preference and a sensory image.

A second aspect of the invention further defines the facility attribute data generating device according to the first aspect as described below.

The device further includes a reliability estimating unit that estimates a reliability of answers to a question based on the extracted log data items, wherein:

the attribute data generating unit generates the attribute data in consideration of the reliability.

The attribute data generating device according to the second aspect defined as above generates the attribute data based on the log data items containing very reliable answers to the question asked, thereby generating attribute data with improved reliability.

The reliability may be defined by the number of the answers to the question and/or a variability of the answers to the question (third aspect). It is possible to incorporate, into the attribute data, more users' sensory images relating to the target facility when there are a greater number of answers to the question. Also, it is possible to incorporate, into the attribute data, most users' common sensory image about the target facility when there is a smaller variability in the answers to the question.

A fourth aspect of the invention provides a facility search device defined as below. The device includes:

an attribute data storage unit that stores the attribute data relating to the facility generated by the attribute data generating device according to any one of claims 1 to 3, the attribute data being stored in the attribute storage unit in association with the facility;

a question display unit that displays a question for a facility search;

an input unit that accepts input of an answer to the question for the facility search; and

a facility search unit that searches for a facility that corresponds to the inputted answer based on the inputted answer and the attribute data.

The facility search device according to the fourth aspect defined as above displays a question corresponding to the attribute data to a user by using the attribute data generated by the attribute data generating device according to any one of the first to third aspects, and search for a facility that corresponds to the user's answer to the question based on the inputted answer and the attribute data. In the above facility search, the user first imagines a facility that the user may want to visit, and then inputs answers to the questions asked. Thus, it is possible to search for a facility with the attribute data item(s) that match for the answer(s). This allows the facility search incorporating the user's sensory image.

A fifth aspect of the invention provides a method for generating attribute data for a facility defined as below.

The method includes steps of:

storing log data items including questions and answers obtained in a game for guessing a facility assumed by a user through an interactive question-answering process, the log data items being stored in a log database in association with the facility;

identifying a facility as a target facility, for which attribute data relating to the facility is to be generated, by using a target facility identifying unit;

extracting one or more of the log data items relating to the identified target facility from the log database by using a log data extracting unit; and

generating the attribute data relating to the target facility based on the extracted log data items by using an attribute data generating unit.

The method according to the fifth aspect defined as above provides advantages similar to the first aspect.

A sixth aspect of the invention is defined as below.

The facility attribute data generating method according to claim 5 further includes a step of estimating a reliability of answers to a question based on the extracted log data items by using a reliability estimating unit, wherein:

the generating the attribute data includes generating the attribute data in consideration of the reliability.

The method according to the sixth aspect defined as above provides advantages similar to the second aspect.

A seventh aspect of the invention is defined below.

In the facility attribute data generating method according to claim 5 or 6, the reliability is defined by the number of the answers to the question and/or a variability of the answers to the question.

The method according to the seventh aspect defined as above provides advantages similar to the third aspect.

An eighth aspect of the invention provides a facility search method defined as below. The method includes steps of:

storing the attribute data relating to the facility generated by the attribute data generating method according to any one of claims 5 to 7, the attribute data being stored in association with the facility;

displaying a question for a facility search by using a question display unit;

accepting input of an answer to the question for the facility search by using an input unit; and

searching for a facility that corresponds to the inputted answer based on the inputted answer and the attribute data by using a facility search unit.

The method according to the eighth aspect defined as above provides advantages similar to the fourth aspect.

A ninth aspect of the invention is further defined as below.

A computer program for generating attribute data for a facility causes a computer to function as:

storing means for storing log data items including questions and answers obtained in a game for guessing a facility assumed by a user through an interactive question-answering process, the log data items being stored in a log database in association with the facility;

target facility identifying means for identifying a facility as a target facility for which attribute data relating to the facility is to be generated;

log data item extracting means for extracting one or more of the log data items relating to the identified target facility from the log database; and

attribute data generating means for generating the attribute data relating to the target facility based on the extracted log data items.

The computer program according to the ninth aspect defined as above provides advantages similar to the first aspect.

A tenth aspect of the invention is further defined as below.

The computer program according to claim 9 further causes the computer to function as reliability estimating means for estimating a reliability of an answer to a question based on the extracted log data items, wherein:

the attribute data generating means generates the attribute data in consideration of the reliability.

The computer program according to the tenth aspect defined as above provides advantages similar to the second aspect.

An eleventh aspect of the invention is further defined as below.

In the computer program according to claim 9 or 10, the reliability is defined by the number of the answers to the question and/or a variability of the answers to the question.

The computer program according to the eleventh aspect defined as above provides advantages similar to the third aspect.

A twelfth aspect of the invention is defined as below.

A computer program for a facility search causes a computer to function as:

attribute data storing means for storing the attribute data relating to the facility generated by the computer program according to any one of claims 9 to 11, the attribute data being stored in association with the facility;

question display means for displaying a question for a facility search;

input means for accepting input of an answer to the question for the facility search; and

facility search means for searching for a facility that corresponds to the inputted answer based on the inputted answer and the attribute data.

The computer program according to the twelfth aspect defined as above provides advantages similar to the fourth aspect.

A thirteenth aspect of the invention is defined as a recording medium for recording the computer program according to any one of the ninth to twelfth aspects.

### BRIEF DESCRIPTION OF THE DRAWINGS

FIG. 1 is a block diagram of an attribute data generating device 1 according to an embodiment of the invention.

FIG. 2A is a table showing an example of log data items of a facility X stored in a log database 3; and FIG. 2B is a table showing an example of data stored in an attribute data storage unit 11.

FIG. 3 is a block diagram of an attribute data generating device 21 according to another embodiment of the invention.

FIG. 4 is a flow chart illustrating one example of an operation of the attribute data generating device 21 according to another embodiment of the invention.

FIG. 5 is a computer program constituting the attribute data generating device 21 according to another embodiment of the invention.

FIG. 6 is a block diagram of a facility search device 31 according to an embodiment of the invention.

FIG. 7 is a block diagram of a mobile terminal device 51 according to an example of the invention.

### EMBODIMENTS OF THE INVENTION

Hereinafter, embodiments of a device for generating attribute data for a facility are described.

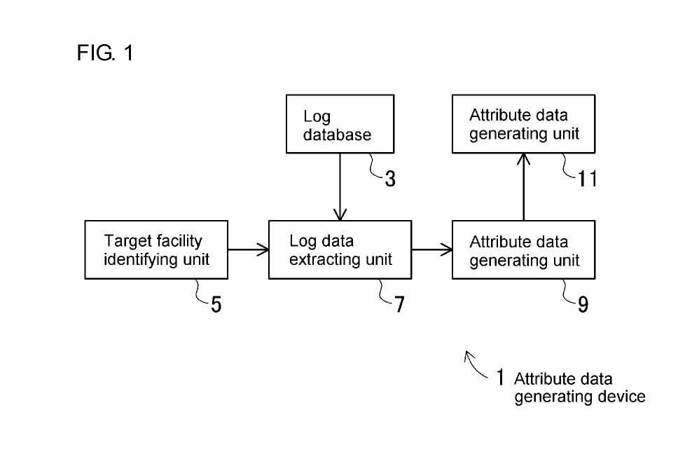

FIG. 1 illustrates a schematic structure of an attribute data generating device 1.

As illustrated in FIG. 1, the attribute data generating device 1 includes a log database 3, a target facility identifying unit 5, a log data extracting unit 7, an attribute data generating unit 9, and an attribute data storage unit 11.

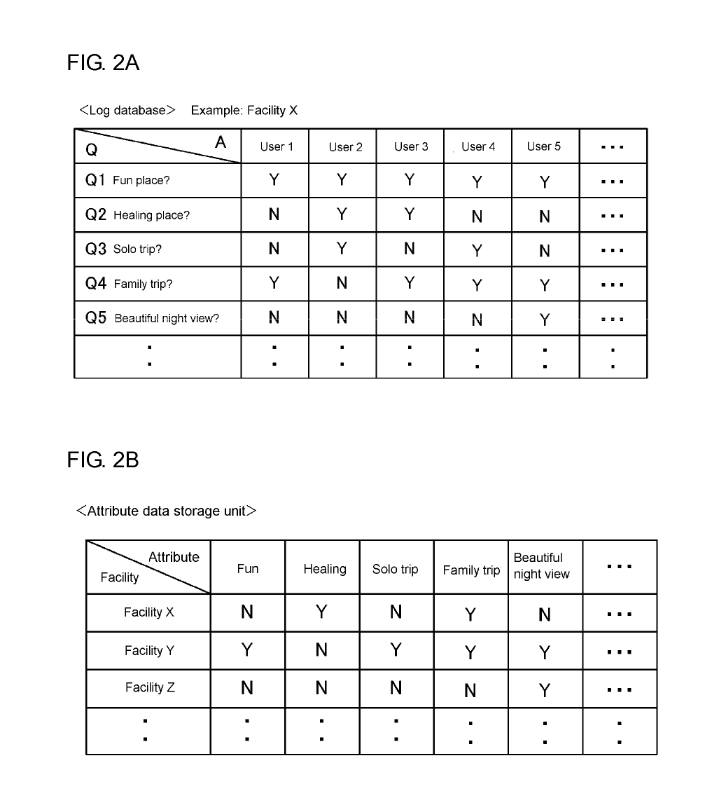

The log database 3 stores, in association with the corresponding facility, log data items of questions and answers, which items are obtained in a game for guessing the predetermined facilities assumed by a user through an interactive question-answering process. FIG. 2A is one example of log data items of a facility X stored in the log database 3. The log database 3 may store, as the log data items, all users' answers to questions asked or a certain number of the most recent answers by the users. Other examples of the log data items include data associated with the number of answers to the question, or data associated with a variability of the answers to the question.

The target facility identifying unit 5 identifies a facility as a target facility for which attribute data is to be generated by the later-described attribute data generating unit 9. The target facility may be optionally identified by any suitable manner, for example, by directly inputting a facility name via an input unit described later or by tapping the facility on a map displayed on a display unit. When, for example, a list of facility names associated with the log data items stored in the log database 3 is displayed, the target facility may be identified by tapping on one of the listed facilities.

The log data extracting unit 7 extracts, from the log database 3, some log data items relating to the target facility identified by the target facility identifying unit 5. The log data items may be optionally extracted by any suitable manner, for example, by extracting entirety of the log data items associated with the target facility or by exclusively extracting the log data items that satisfies a predetermined condition. Examples of the predetermined condition include that the log data items are obtained in a predetermined time period, that the number of answers to the question is equal to or greater than a predetermined threshold value, or that a variability of the answers to the question falls within a predetermined range.

The attribute data generating unit 9 generates the attribute data for the identified target facility based on the log data items extracted by the log data extracting unit 7. The attribute data may be optionally generated by any suitable manner. The question “Is it a fun place?” is employed as an example among the questions included in the log data items associated with the target facility. When a proportion of “Yes” answers to the question is equal to or greater than a predetermined threshold value, the attribute data generating unit 9 may generate attribute data indicating that the target facility is “a fun facility”. Alternatively, the attribute data generating unit 9 may generate attribute data for each day of a week and/or each time slot within a day based on information on dates, time, and days of a week associated with the answer. The generated attribute data is associated with the target facility and then stored in the attribute data storage unit 11. FIG. 2B illustrates an example of data stored in the attribute data storage unit 11.

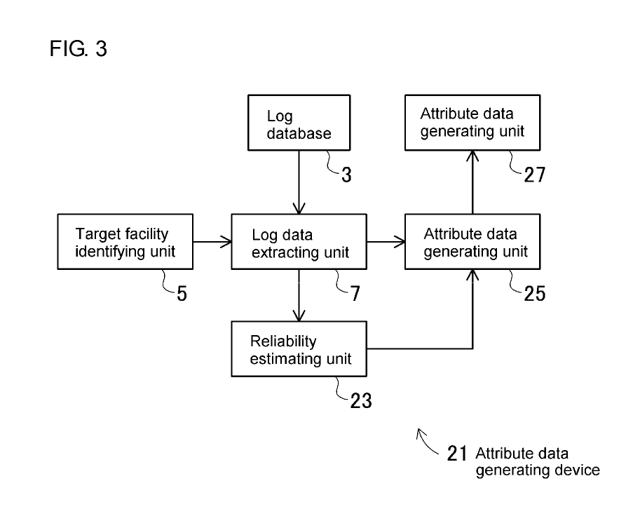

FIG. 3 is a drawing of an attribute data generating device 21 according to another embodiment of the invention. The elements of FIG. 3 similar to the ones of FIG. 1 are illustrated with the same reference symbols, and the description of the elements will be partly omitted.

The attribute data generating device 21 illustrated in FIG. 3 is capable of generating the attribute data in consideration of the reliability of answers to a question in the log data items. Specifically, the attribute data generating device 21 further includes a reliability estimating unit 23 in addition to the structure of the device 1 illustrated in FIG. 1, and the attribute data generating unit 9 and the attribute data storage unit 11 are respectively replaced with an attribute data generating unit 25 and an attribute data storage unit 27.

The reliability estimating unit 23 estimates a reliability of answers to the question based on the log data items extracted by the log data extracting unit 7. For example, it is possible to generate attribute data incorporating more users' sensory images about the target facility if a greater number of answers to the question is available. This improves the reliability of the generated attribute data. In another case, it is possible to generate attribute data incorporating most users' common sensory image about the target facility when there is a smaller variability in the answers to the question. This also improves the reliability of the generated attribute data. In this manner, the reliability estimating unit 23 estimates the reliability of the answers in the extracted log data items based on the number of answers to the question and the variability of the answers to the question. The reliability may be optionally estimated by any suitable manner. For example, in the former reliability estimation, the reliability estimating unit 23 may estimate that the answers are “reliable” when the number of answers is equal to or greater than a predetermined threshold value. Alternatively, the reliability estimating unit 23 may estimate the reliability in multiple levels (e.g., five levels) depending on the number of answers. In the latter reliability estimation, the reliability estimating unit 23 may rely on a degree of bias in the answers computed by a statistical approach and may determine the answers as “reliable” when the bias in the answers is large. Similar to the former case, the reliability estimating unit 23 may also estimate the reliability in five levels depending on the obtained degree of bias.

The attribute data generating unit 25 of the device 21 refers to the log data extracting unit 7 and the reliability estimating unit 23, and generates the attribute data based on the estimated-as-“reliable” questions and answers included in the extracted log data items.

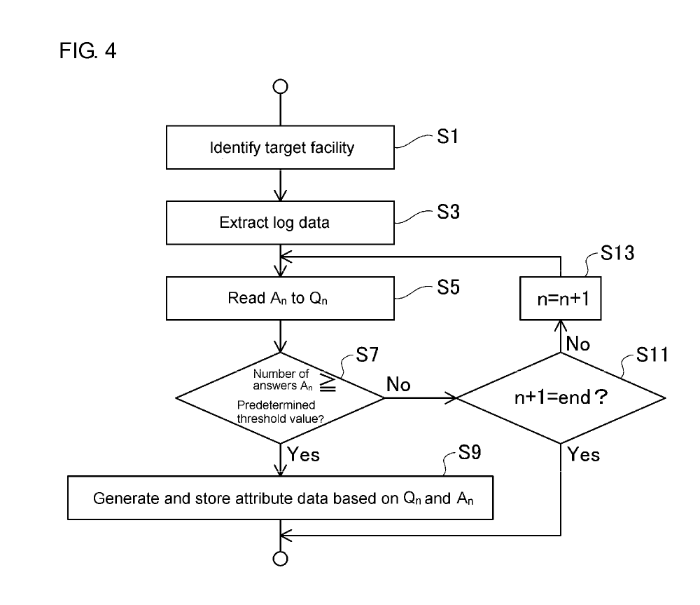

One example of an operation of the attribute data generating device 21 illustrated in FIG. 3 is described with reference to FIG. 4.

In Step 1, the target facility identifying unit 5 identifies a target facility for which attribute data is to be generated. For example, the target facility may be selected, through the later-described input unit, from a list of facility names generated based on the log data items stored in the log database 3.

In Step 3, the log data extracting unit 7 refers to the log database 3 and the target facility identifying unit 5, and extracts the log data items associated with the target facility identified in Step 1.

In Step 5, the reliability estimating unit 23 reads answers Aₙ to a question Qₙ from the log data items extracted in Step 3.

In Step 7, the reliability estimating unit 23 estimates the reliability of answers to each question in the log data items extracted in Step 3. The reliability may be estimated based on, for example, whether the number of answers Aₙ to the question Qₙ is equal to or greater than a predetermined threshold value. When the estimation result shows that the number of answers is equal to or greater than the predetermined threshold value (Step 7: Yes), the control proceeds to Step 9.

In Step 9, the attribute data generating unit 25 generates the attribute data for the target facility identified in Step 1 based on Aₙ and Qₙ. Then, the generated attribute data is stored.

When the estimation result indicates No in Step 7, Steps 5 and 7 are executed for a question Qₙ₊₁ that follows the question Qₙ (Steps 11 and 13).

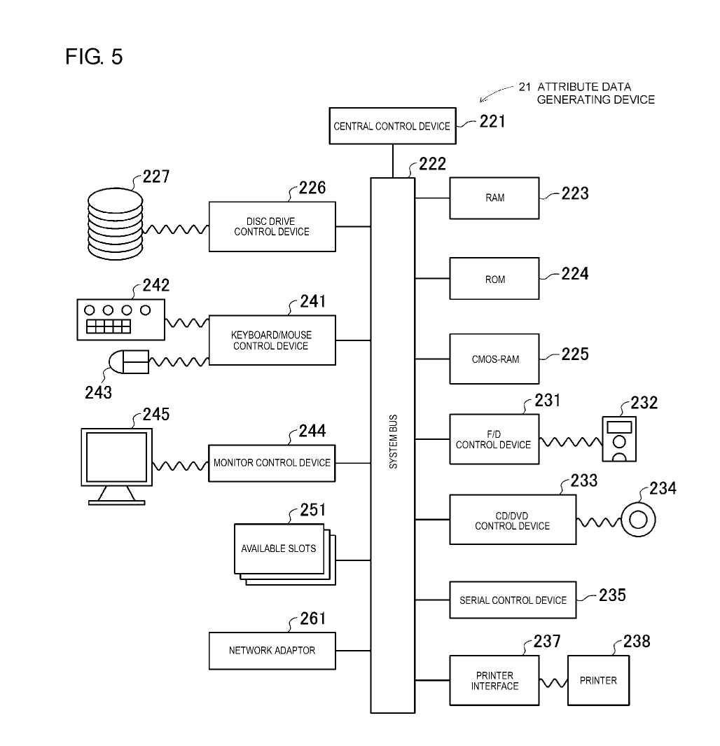

FIG. 5 is a block diagram illustrating a hardware configuration of the attribute data generating device 21.

Similar to any conventional computer systems, the hardware configuration of this device 21 includes various elements connected to a central controller 221 through a system bus 222.

The central controller 221 includes a general-purpose CPU, a memory controller, a bus controller, an interrupt controller, and a DMA (direct memory access) device. The system bus 222 includes data lines, address lines, and control lines. The system bus 222 has a memory circuit connected thereto, and the memory circuit includes a RAM (random access memory) 223 and non-volatile memories (a ROM 224 and a CMOS-RAM 225). Data stored in the RAM 223 is read out and/or rewritten by the central controller 221 or the other hardware components. Data stored in the non-volatile memories is read-only and will not be lost even when the device is turned off. A system program that controls the hardware components is stored in a hard disc device 227 and the RAM 223. The system program is read through a disc drive controller 226 into the central controller 221 and then used. The hard disc device 227 has a region to store therein a computer program that causes a general-purpose computer system to operate as the attribute data generating device 21.

A predetermined region of the hard disc device 227 is assigned for a storage unit for storing therein pieces of information identified or processed by the target facility identifying unit 5, the log data extracting unit 7, the reliability estimating unit 23, and the attribute data generating unit 25.

The remaining region of the hard disc device 227 is assigned for the storage units 3 and 27 for respectively storing therein the log database and generated attribute data.

The system bus 222 has a flexible drive controller 231 and a CD/DVD controller 233 connected thereto. The flexible drive controller 231 writes data in and reads data from a flexible disc 232, and the CD/DVD controller 233 reads data from a compact disc 234. In the illustrated example, a printer 238 is connected to a printer interface 237.

A keyboard and mouse controller 241 is connected to the system bus 222 to allow data input via a keyboard 242 and a mouse 243. A monitor 245 is connected to the system bus 222 through a monitor controller 244. Examples of the monitor 245 include a CRT monitor, a liquid crystal monitor, and a plasma display monitor.

The device further includes empty slots 251 for installing additional devices, such as a modem.

Programs (OS program, application programs including the program according to the present invention) are installed in the computer system via various recording media. The above programs are necessary for the computer system to operate as the attribute data generating device 21. Examples of the recording media include non-rewritable recording media (such as a CD-ROM, a ROM card) and rewritable recording media (such as an FD, a DVD). The programs may be installed through a communication medium available on a network N. It should be understood that these programs may be written in advance in the non-volatile memory 224, 225 and/or the hard disc device 227.

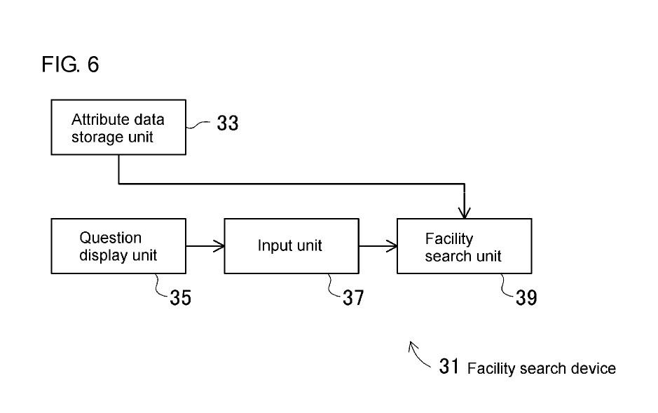

FIG. 6 illustrates a schematic structure of a facility search device 31 according to an embodiment of the invention. The elements of FIG. 6 similar to the ones of FIGS. 1 and 3 are illustrated with the same reference symbols, and the description of the elements will be partly omitted.

FIG. 6 illustrates the facility search device 31 capable of searching for a facility with attributes required by a user based on displayed questions relating to the facility attributes and answers inputted by the user to the questions. Specifically, the facility search device 31 includes an attribute data storage unit 33, a question display unit 35, an input unit 37, and a facility search unit 39.

The attribute data storage unit 33 stores therein the facility attribute data items, which are generated by the attribute data generating device, in association with the relevant facilities.

The question display unit 35 displays a question for facility search. Examples of the displayed questions include a question asking whether the attribute exists or not, which attribute is obtained from the attribute data storage unit 33. For example, a question, “looking for a facility for your family trip?” may be displayed as the question for asking about the attribute “family trip”. The question display unit 35 may display questions in a dialogue format using the later-described input unit 37 or may collectively display a list of questions.

The input unit 37 receives input of a user's answers to questions. The user's answer may be optionally inputted by any suitable manner. For example, choices “Yes” and “No” are displayed for a question “looking for an indoor facility?”, and the input unit 37 receives the user's operation of selecting preferable one of the choices. As above, the answer by the user is inputted. The input unit 37 transmits the inputted answers and the displayed questions to the later-described facility search unit 39.

The facility search unit 39, by referring to the attribute data storage unit 33, searches for a facility that corresponds to the inputted answers. The search method may provide, as a search result, any facility that satisfies all of the inputted answers, and the search result may be “no facility found” if none of the facilities satisfies all of the inputted answers. Even if none of the facilities satisfies all of the inputted answers, the search result may present a facility that satisfies the largest number of answers. In the above case, the search result may also contain a matching ratio between the attributes of the facility desired by the user and the attributes of the facility presented by the search result.

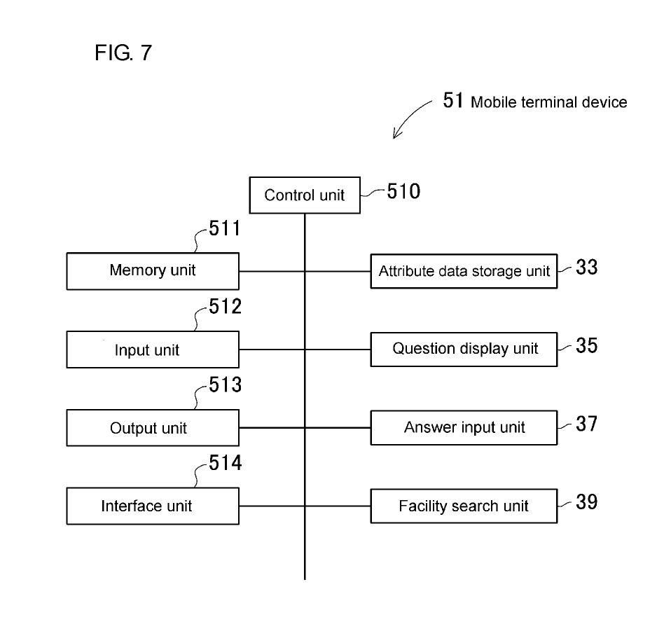

FIG. 7 illustrates a mobile terminal device 51 equipped with the device 31 illustrated in FIG. 6. The elements of FIG. 7 similar to the ones of FIGS. 1, 3, and 6 are illustrated with the same reference symbols, and the description of the elements will be partly omitted.

The mobile terminal device 51 includes a control unit 510, a memory unit 511, an input unit 512, an output unit 513, an interface unit 514, an attribute data storage unit 33, a question display unit 35, an input unit 37, and a facility search unit 39.

The control unit 510 is a computer including devices such as a CPU and a buffer memory and controls the elements of the mobile terminal device 51.

The memory unit 511 stores therein a computer program, which is read into the control unit 510 as the computer, to cause the control unit 510 to function. The computer program may be stored in a storage medium of the mobile terminal device, a replaceable recording medium of the mobile terminal device, or a general-purpose recording medium. Examples of the storage medium include a built-in hard disc and a built-in memory. Examples of the replaceable recording medium include an SD (registered trademark) memory card, a memory stick, a smart medium, a compact flash (registered trademark). Examples of the general-purpose recording medium include a DVD.

The input unit 37 is used to input user's instructions, and specifically is used to input answers to questions displayed on the question display unit 35. The input device 37 may be a pointing device, a keyboard, or an audio input device. Examples of the pointing device include a mouse, a light pen, a touch panel that works with displayed data. Examples of the audio input device include a microphone.

The output unit 513 includes a display device that displays questions the question display unit 35 provides, an answer input screen, search results obtained by the facility search unit 39, and other pieces of information. The output unit 513 may include an audio output unit.

The interface unit 514 connects the mobile terminal device 51 to a wireless network and the like.

The embodiments and an example of the present invention are described as above. Two or more of the above embodiments (example) may be exercised in combination. Alternatively, one of the embodiments (example) may be partially exercised. Furthermore, two or more of the embodiments (example) may be partially exercised in combination.

The invention is not restricted by the embodiments and example of the present invention described above. The invention encompasses any modifications as long as the modifications are easily anticipated by those skilled in the art and fall within the scope of the invention defined by the appended claims.

### DESCRIPTION OF REFERENCE SYMBOLS

1, 21 attribute data generating device
3 log database
5 target facility identifying unit
7 log data extracting unit
9, 25 attribute data generating unit
11, 27, 33 attribute data storage unit
23 reliability estimating unit
31 facility search device
35 question display unit
37 input unit
39 facility search unit

1. A device for generating attribute data for a facility, comprising:
a log database that stores log data items including questions and answers obtained in a game for guessing a facility assumed by a user through an interactive question-answering process, the log data items being stored in the log database in association with the facility;
a target facility identifying unit that identifies a facility as a target facility, for which attribute data relating to the facility is to be generated;
a log data extracting unit for extracting one or more of the log data items relating to the identified target facility from the log database; and
an attribute data generating unit that generates the attribute data relating to the target facility based on the extracted log data items.

2. The device for generating attribute data for the facility according to claim 1, further comprising a reliability estimating unit that estimates a reliability of answers to a question based on the extracted log data items, wherein:
the attribute data generating unit generates the attribute data in consideration of the reliability.

3. The device for generating attribute data for the facility according to claim 1, wherein:
a reliability of the answers is defined by the number of the answers to a question and/or a variability of the answers to a question.

4.-8. (canceled)

9. A tangible non-transitory computer-readable storage medium that contains a computer program for generating attribute data for a facility, the computer program causing a computer to function as:
storing device that stores log data items including questions and answers obtained in a game for guessing a facility assumed by a user through an interactive question-answering process, the log data items being stored in a log database in association with the facility;
target facility identifying device that identifies a facility as a target facility for which attribute data relating to the facility is to be generated;
log data item extracting device that extracts one or more of the log data items relating to the identified target facility from the log database; and
attribute data generating means device that generates the attribute data relating to the target facility based on the extracted log data items.

10. The storage medium according to claim 5, further causing the computer to function as a reliability estimating device that estimates a reliability of an answer to a question based on the extracted log data items, wherein:
the attribute data generating means generates the attribute data in consideration of the reliability.

11. The storage medium according to claim 5, wherein the reliability is defined by the number of the answers to the question and/or a variability of the answers to the question.

12. A tangible non-transitory computer-readable storage medium that contains a computer program for a facility search, the computer program causing a computer to function as:
attribute data storing device that stores the attribute data relating to the facility generated by the computer program according to any one of claim 5, the attribute data being stored in association with the facility;
question display device that displays a question for a facility search;
input device that accepts input of an answer to the question for the facility search; and
facility search device that searches for a facility that corresponds to the inputted answer based on the inputted answer and the attribute data.

13. (canceled)

14. The device for generating attribute data for the facility according to claim 2, wherein:
the reliability is defined by the number of the answers to the question and/or a variability of the answers to the question.

15. The storage medium according to claim 10, wherein the reliability is defined by the number of the answers to the question and/or a variability of the answers to the question.
